(19) United States
(12) Patent Application Publication
(10) Pub. No.: US 2011/0097156 A1
(43) Pub. Date: Apr. 28, 2011

(54) Pipe Laying Apparatus and Method

(76) Inventor: Jean-Baptiste Pose, Aberdeen (GB)

(21) Appl. No.: 12/672,862

(22) PCT Filed: Aug. 11, 2008
(86) PCT No.: PCT/GB2008/050694

§ 371 Date: Jan. 12, 2011

(30) Foreign Application Priority Data
Aug. 10, 2007 (GB) 0715549.2

(51) Int. Cl. F16L 1/12

(52) U.S. Cl. 405/166

(57) ABSTRACT

Apparatus for overboarding an article from a pipe laying vessel includes a pipe laying tower (10) that is mounted above a tower supporting platform. The tower has tensioners (20) for suspending a pipeline (34) being laid from the pipelaying vessel into the sea and adjusters for adjusting inclination of the tower to align the tensioners with a departure axis of a pipeline being laid. A hoist (26, 27, 32) allows large articles (25) to be suspended from the tower. Adjusters (16) allow the tower to be angled beyond the departure axis, such that the hoist suspends the article outboard of the platform. Articles too large to pass the tower supporting platform of the vessel can be maneuvered first outboard of the tower supporting platform, then lowered and brought beneath the tower supporting platform back into line with the departure axis for connection to the pipeline. A method of laying pipe line from a vessel is also provided.

### FIELD & BACKGROUND DISCUSSION

The present invention relates to pipe laying apparatus, particularly, but not exclusively, pipe laying apparatus which allows overboarding of oversized articles such as Pipe Line End Termination (PLET) or In Line Tee (ILT) modules from a pipelaying vessel. A method of overboarding articles from a pipe laying vessel using rigid pipeline, flexible pipeline, cables or umbilicals is also provided.

Overboarding involves moving such articles from a starting position, that is on or above the deck, to an overboard position that is outboard of the edge of the vessel deck and over the water. The article can then be lowered into the water past the main body of the vessel, using e.g. a winch. Finally, the article can then be brought inward from its outboard position such that it is suspended under the main body of the vessel.

There are numerous offshore operations which require overboarding of bulky articles such as PLET and ILT modules to be carried out. An example of when this is necessary is when a module is attached to the end of a pipeline being laid by a pipe laying vessel. Certain vessels have a slot in the rear (transom) of the deck which allows the pipeline to pass therethrough for connection to the pipe laying tower. However, such slots have a limited width. Clearly, if the width of the module is greater than the width of the slot it cannot pass through the slot. Additional equipment in the form of a heavy lifting crane is then required to manipulate larger items, perhaps even requiring attendance by a separate lifting vessel, and requiring very calm conditions for safe operation.

According to a first aspect of the present invention, there is provided pipe laying apparatus for overboarding an article from a pipe laying vessel, the apparatus comprising:
a pipe laying tower mounted generally above a tower supporting platform of the vessel, the tower including tensioning apparatus for suspending a pipeline being laid from the pipelaying vessel into the sea;
means for adjusting inclination of the tower to align said tensioning apparatus with a departure axis of a pipeline being laid;
apparatus for handling large articles, whereby articles too large to pass the tower supporting platform of the vessel may be supported and maneuvered first outboard of said tower supporting platform, then lowered and brought beneath said tower supporting platform back into line with the departure axis for connection to the pipeline;
a hoist for suspending said large articles from an upper part of said tower; and
means for adjusting the inclination of the tower to an angle beyond that of the departure axis, such that said hoist suspends the article outboard of the tower supporting platform for lowering past the tower supporting platform.

The tower supporting platform may have a slot through which pipe may be laid during a typical pipe laying operation, where the width of the slot determines whether the large article is able to pass through the slot into the sea without having to be overboarded by the apparatus.

The apparatus allows an oversized article to be lowered off the rear of the vessel without passing through the slot and hence without being obstructed by the tower supporting platform. The skilled person will realise that if the article being lowered is a PLET or ILT module on a length of pipeline being laid, the angle of the tower relative to the deck may not need to be so large that the tower itself projects overboard from the rear of the vessel. Rather, in the correct circumstances, the tension of the pipeline may pull the module (at the catenary angle of the pipeline) toward the rearward position. Lowering of the module from this position using the winch means results in the module being lowered overboard clear of the vessel transom. At the same time, the need for an additional crane on board the vessel or on a separate vessel is avoided, and the range of sea states in which the operation can be performed is increased.

The means for adjusting the inclination of the tower may be capable of moving the tower to an angle at least equal to, and preferably greater than, ninety degrees relative to the deck of the vessel, such that the top of the tower projects outboard from the tower supporting platform. The adjusting means may also preferably be capable of at least partially securing the tower in said position.

In the envisaged application, the suspended article will comprise a module such as a PLET or ILT, which is to be fitted to a pipeline being laid through the tensioning means. The module can be overboarded while attached to a pipeline being laid, where the article has a width which is greater than the tower supporting platform slot through which the pipeline is being laid. This would apply to second end PLETs and ILTs in particular. For ‘first end’ PLETs, the module will be overboarded prior to attachment to the main length of pipeline.

The means for adjusting inclination of the tower to align said tensioning apparatus with a departure axis and the means for adjusting the inclination of the tower to an angle beyond that of the departure axis preferably comprise the same means. The means may comprise at least an adjuster leg extending between a portion of the tower and a portion of the vessel deck. Preferably, a pair of substantially parallel adjuster legs are provided.

The hoist may comprise at least a sheave carried at an upper part of the tower typically located toward the top of the tower, and a hoist cable wrapped therearound. The hoist may also include a cursor mechanism for selectively guiding the cable along the tower, where the cursor mechanism is selectively disengageable and reengageable with the cable when the hoist raises the article past the rear of the vessel. Optionally, the cable comprises an abandonment and recovery line.

Typically, the tower comprises an A-frame having legs laterally spaced apart to provide a tower aperture for passage of modules from storage to the departure axis and where each leg is hinged to the tower supporting platform at pivot points. Typically, a tower aperture is provided by the A-frame where the width of the aperture is substantially defined by the distance between the spaced apart legs and the height of the aperture is substantially defined by the distance between the deck of the vessel and a cross brace member of the A-frame.

The pipe laying apparatus may further comprise pipe laying tower bypass means for moving an article, having dimensions greater than the tower aperture, from a location which is forward of the pipe laying tower to a location rearward of the pipe laying tower. Optionally, the tower bypass means comprises a crane capable of lowering the article overboard to a subsea position. The cable of the hoist can then be connected to the article and the article winched onboard to the rearward position.

According to a second aspect of the present invention, there is provided a method of overboarding an article from a pipe laying vessel in a pipe laying operation, the method comprising:
providing a pipe laying tower generally above a tower supporting platform of the vessel;
paying out a pipeline using tensioning apparatus in the tower past the tower supporting platform and into the sea, the tower being inclined to align said tensioning apparatus with a departure axis of the pipeline being laid;
prior to or after paying out said pipeline, using a hoist to suspend an article from an upper part of said tower;
adjusting the inclination of the tower to an angle beyond that of the departure axis, such that said hoist suspends the article outboard of said tower supporting platform;
using the hoist to lower the article past the tower supporting platform.

The method may further comprise:
with the article suspended outboard of and below the level of the tower supporting platform, adjusting the inclination of the tower back to said departure angle so as to bring the article onto the departure axis below the tower supporting platform; and
connecting said article to a section of pipeline held in the tensioning apparatus prior to paying out pipeline.

The method may further comprise:
providing a slot in the tower supporting platform and paying out the pipeline through said slot and into the sea and, and wherein the step of adjusting the inclination of the tower to an angle beyond that of the departure axis suspends the article outboard of said slot; and
using the hoist to lower the article past the slot rather than through it.

The method may alternatively or in addition include:
after paying out a length of pipeline, gripping the pipeline below the tensioning apparatus and cutting it to form an upper end of said pipeline held in the slot;
prior to passing said article outboard of the vessel, using said hoist, attaching a lower end of the article to the upper end of the pipeline.

The step of adjusting the inclination of the tower may include moving the tower to an angle at least equal to, and preferably greater than, ninety degrees relative to the deck of the vessel such that the top of the tower projects overboard from the slot.

The step of adjusting the inclination of the tower to align said tensioning apparatus with a departure axis and the step of adjusting the inclination of the tower to an angle beyond that of the departure axis may comprise a combined step using a single adjusting means.

The step of using a hoist to suspend said large articles from an upper part of said tower may comprise hoisting the article with a hoist provided at the tower wherein the hoist comprises at least a sheave typically located toward the top of the tower, a winch located at the tower and a hoist cable wrapped therearound. The step of hoisting the article may further comprise disengaging a cursor mechanism from the hoist cable as the article is being hoisted past the rear of the vessel. The step of hoisting may also include re-engaging the cursor mechanism when the article is suspended below the slot.

The cursor mechanism may comprise, winch means, winch cable and sheave, an abandonment trolley capable of restraining the winch cable along the height of the tower, and an underwater hook.

The abandonment trolley is provided with a sheave. In the case where the abandonment axis is angled away from the tower angle, this sheave assists movement of the winch cable and allows the winch cable to be diverted, above the sheave, in line with the tower axis.

The method may also optionally comprise the step of moving a large article having dimensions greater than an aperture in the tower, from a location which is forward of the tower to a location rearward of the tower by bypassing the tower. The step of bypassing the tower may comprise lowering the article from the forward location into the sea using a crane, transferring the article to the hoist means of the tower, and raising the article onto the deck of the vessel at the rearward position.

The step of bypassing the tower may alternatively comprise folding over hinged portions of the article in order to temporarily reduce the effective dimensions of the article, and moving the article rearward through the aperture in the tower.

### BRIEF DESCRIPTION OF THE DRAWINGS

Embodiments of the invention will now be described, by way of example only, with reference to the accompanying drawings, in which:

FIG. 1 is a stern view of a vessel provided with pipelaying apparatus according to one embodiment of the present invention;

FIG. 2 is a plan view of the apparatus of FIG. 1;

FIGS. 3 to 5 are schematic transverse views of the apparatus of FIGS. 1 and 2 where the tower is angled inboard at 60, 45 and 30 degrees respectively relative to the deck of the vessel;

FIG. 6 is a schematic transverse view of the apparatus of FIGS. 3 to 5 where the tower is angled outboard at an angle equal to or greater than 90 degrees relative to the deck of the vessel;

FIG. 7 is a detailed transverse view of part (a cursor) of the hoist provided on the tower of the apparatus;

FIG. 8 is a further stern view of the apparatus of FIG. 1 illustrating the dimensions of a mid sized module having dimensions which allow it to pass through the legs of the pipelaying tower but prevent it from passing through a slot in the deck of the vessel;

FIG. 9 is a transverse view of the apparatus of FIG. 8 showing a PLET as an example of such a module, prior to delivery to the vessel firing line; with tail section of pipe, after passing through the tower;

FIG. 11 is a transverse view of the apparatus showing the tower angled at an overboard position in order to lower the PLET past the rear of the vessel without passing through the slot in the deck;

FIG. 12 is a transverse view of the apparatus where the tower has returned to the vertical position in order to secure the PLET below the slot of the vessel;

FIG. 13 is a further view of the apparatus of FIG. 12 where the PLET and tail piece are held in the firing line below the tower and disconnected from the tower hoist;

FIG. 14 is a view of the apparatus of FIG. 1 illustrating an oversized PLET having dimensions which prevent it from passing through the legs of the pipe laying tower and the slot in the vessel deck;

FIG. 15 is a transverse view of the vessel deck showing a discrete crane for lowering the PLET of FIG. 14;

FIGS. 16 and 17 are plan views of a pair of hingeable sheaves of the cursor shown in FIG. 7 in open and closed positions;

FIG. 18 is an illustration of the oversized PLET suspended sub sea and in handover to the pipe laying tower from the discrete deck crane of the vessel;

FIGS. 19 to 24 are transverse views of the apparatus bringing in the PLET of FIG. 18 toward an onboard position which is aft of the pipe laying tower and then lowering on pipeline;

FIGS. 25 to 27 are transverse views of the apparatus lowering an ILT; and

FIG. 28 is a rear end view of the apparatus of FIGS. 25 to 27.

### DETAILED DESCRIPTION OF THE EMBODIMENTS

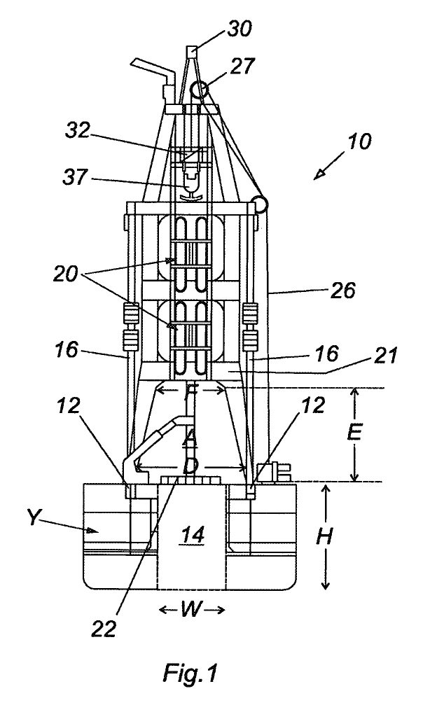

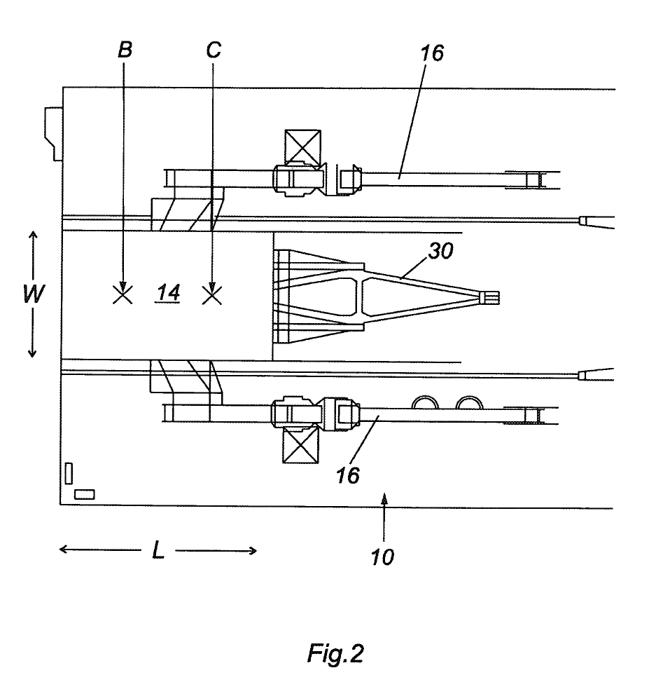

FIGS. 1 and 2 show the apparatus comprising a tower 10 provided at the rear of a pipe laying vessel V. The vessel V is installed with typical pipelaying equipment including the laying tower 10, reels (not shown), tensioners 20, hang off clamp 22, module handling equipment 24 (shown in FIGS. 9-13) and abandonment and recovery (A&R) cable 26. In the embodiment shown, the vessel V has a slot 14 formed in the tower 10 supporting platform area of the vessel's transom. The slot has width W, length L and height H. The laying tower 10 has an abandonment and recovery line situated in line with point B and a tensioner firing line situated in line with point C (FIG. 2).

The tower 10 comprises an A-frame structure which is hinged to the tower supporting platform area of the vessel's transom at pivot points 12, either side of slot 14. The tower 10 is provided with typical pipe laying equipment such as a centraliser and line-up device, upper and lower tensioners 20, pipe straightener 28 (if laying rigid pipe), aligner wheel 30 and abandonment and recovery cursor 32. An aperture A is provided between the legs of the tower. This provides a clear workspace around the firing line, and also allows modules such as PLETs and ILTs as well as any bulky process equipment, to be passed from the main deck to the firing line through the aperture. The aperture A has height E (from the deck to a cross brace member 21), base width D (measured between the pivot points 12) and top width F (effectively equal to the length of the cross brace member 21). These dimensions can be made large enough to pass the most common modules, but there may, on occasion, be modules too large to pass through the aperture. There may also be modules of an intermediate size which, while passing happily through the aperture A, are too wide to be lowered through the slot 14 in the tower supporting platform.

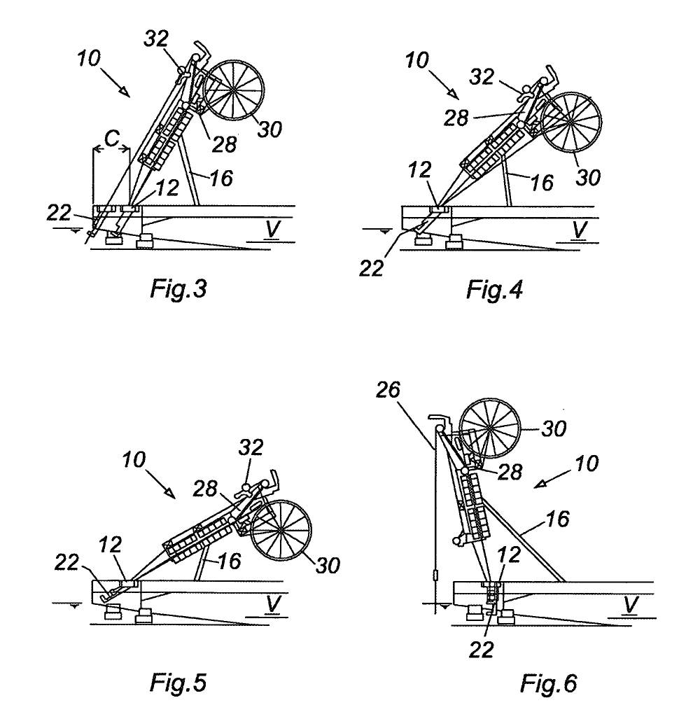

As shown in FIGS. 3 to 5, the tower 10 is moveable between angular inboard positions about the pivot point 12 at the rear of the deck. Movement of the tower 10 is performed by angular actuation means in the form of a parallel pair of tower adjuster legs 16. Rams and latches in the legs allow the angle of the tower 10 to be adjusted relative to the deck to match the catenary angle (or departure axis) of the pipe being laid. As shown in FIG. 6, the tower 10 may also be actuated to an angle greater than ninety degrees such that the top of the tower 10 protrudes overboard from the rear (transom) of the vessel V. This allows the pipelaying tower 10 to be used in a shear leg crane capacity as will be described subsequently.

When it is desired to use the tower 10 as an overboarding crane it is actuated using the tower adjuster legs 16 to an upright position where the top of the tower 10 is overboard from the transom of the vessel V as shown in FIG. 6. In this position, the tower 10 can be used as a shear leg crane by winching items using, for example, abandonment and recovery cable 26. Note that the legs 16 come into tension in this mode.

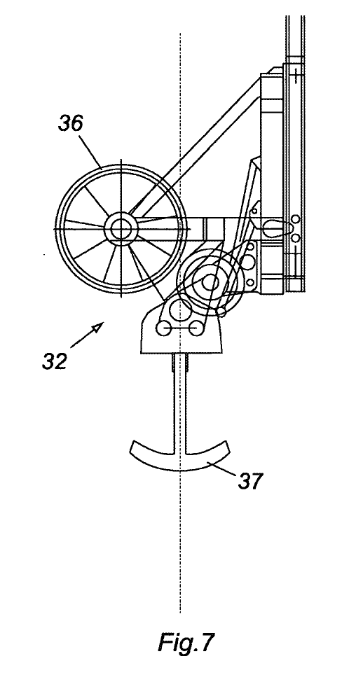

A hoist for abandonment and recovery (A&R) along the A&R line B is provided on the tower. The hoist includes one or more runs of cable each extending over a sheave 27, at the top of the tower 10, down to an A&R winch at deck level. Cursor 32 (seen in more detail in FIG. 7) is mounted to run on a track to different heights on the tower 10. Sheave arrangement 36 is mounted on the cursor, for engaging A&R cable 26 and holding it into the tower. Cable 26 runs through a pulley block 37 load to swing (in a controlled fashion) free of the tower, when being used as an overboarding crane.

A separate deck mounted working crane 18 (shown in FIG. 15) may also be provided on the vessel V for general use, and can be used for overboarding the largest modules, as will be explained later.

Examples of this apparatus in different operational scenarios will now be described.

### Laying First End PLET (Normal Sized)

As a first example of operation of the apparatus, there is considered a first end PLET having a width which is both less than the minimum width F between the tower legs and less than the width W of the slot 14 in the deck of the vessel V. This “normal sized” article may be laid through the slot of the vessel in a known manner and will therefore not be described any further.

### Laying First End PLET (Mid Sized)

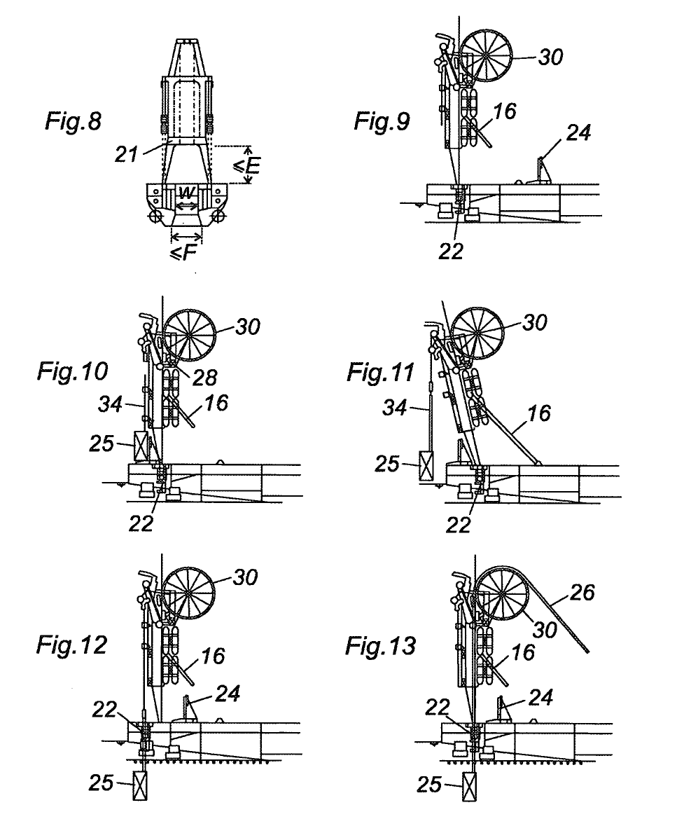

Referring to FIGS. 8 to 13, lowering of a PLET 25, which has a width less than the minimum width F between the tower legs but greater than the width W of the slot 14 in the deck of the vessel V, will now be described.

With the tower 10 in vertical or near vertical position relative to the deck of the vessel V, the mid sized PLET 25 is brought rearward from a storage position (FIG. 9) to a position aft of the apparatus firing line by, suitable PLET handling equipment 24. A first piece of pipeline 34 is welded to the top of PLET 25 (FIG. 10). The abandonment and recovery block 37 is then connected to the top of the first piece of pipeline 34. The weight of the PLET is then taken from the deck of the vessel V by winching the PLET 25 off the deck. At this point the cursor sheaves 36 are opened to disengage the cursor 32 from the cable 26. The PLET 25 is then moved to an overboard position, which is rearward of the tower supporting platform, by jacking the tower 10 to an overboard position using tower adjuster legs 16. The PLET 25 is then lowered past the stern (tower supporting platform) of the vessel using the A & R winches (FIG. 11). Once the PLET 25 is submerged in the sea and is lower than the lowest point of the vessel transom, the tower is then moved inboard again by jacking the tower adjuster legs 16 in the opposite direction. Once the tower 10 has returned to the upright position (FIG. 12) the cursor sheaves 36 are closed to reengage the cursor 32 with the cable 26. The weight of the PLET 25 and first piece of pipeline 34 is now transferred from the cable 26 to the vessel by securing hang off clamp 22 around an upper part of the first piece of pipeline 34. The cable 26 may now be disconnected and retracted. The rest of the pipelaying process can then begin by attaching the rest of the pipeline to the top of the tail piece of pipeline in a known manner.

### Laying First End PLET (Oversized)

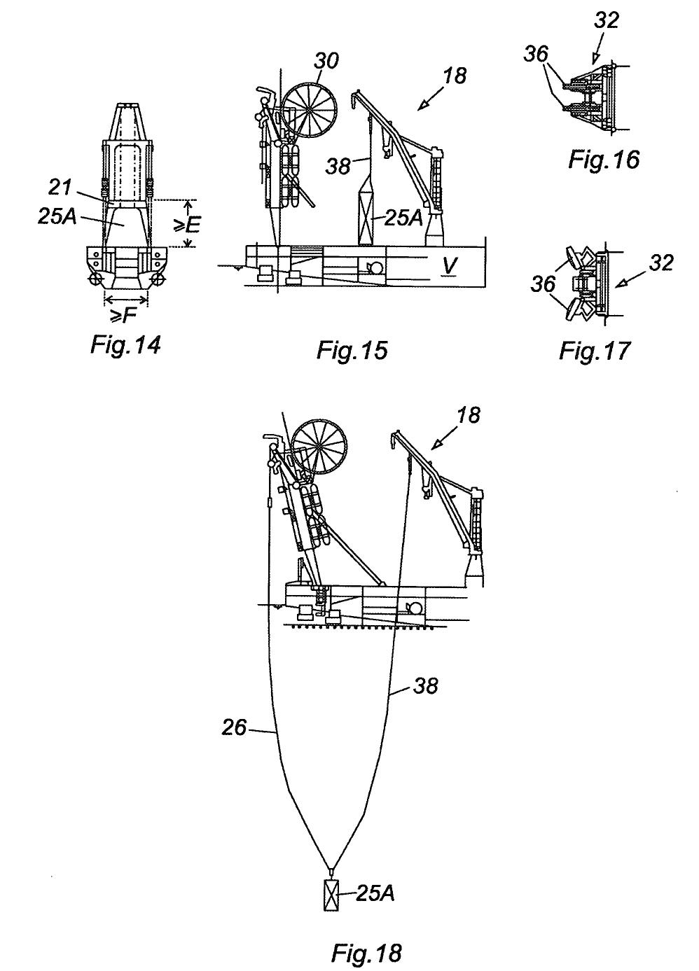

Referring to FIGS. 14 to 24, lowering of a PLET 25, which has a width greater than the minimum width F between the tower legs and greater than the width W of the slot 14 in the tower supporting platform of the vessel V will now be described.

The PLET 25A must be moved rearward of the laying tower 10 in order that it can be positioned over the firing line for subsequent location on the hang off clamp 22. The PLET 25A is too large to pass through the legs of the tower 10, but can be transferred using tower bypass means in the form of a deck mounted working crane 18.

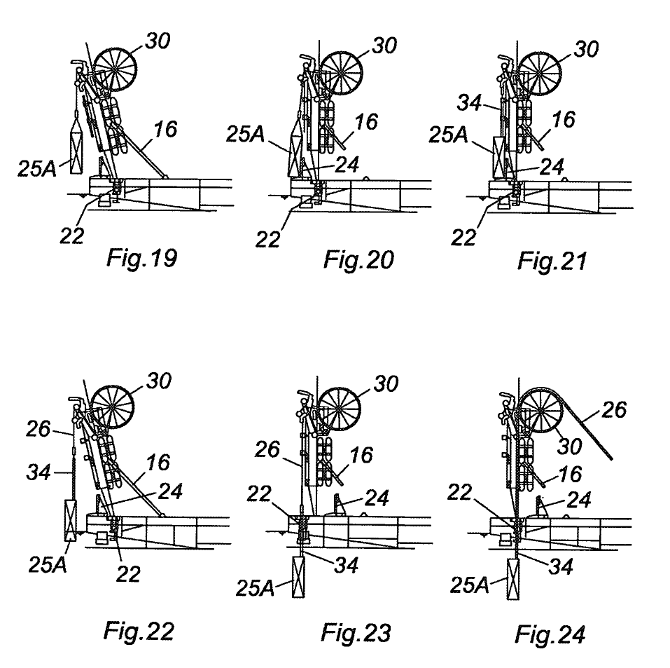

Firstly, the PLET 25A is lowered into the sea below the vessel by the crane 18. The adjuster legs 16 are actuated to move the tower 10 to an outboard position. Abandonment and recovery cable 26 of the pipe laying tower is then connected to the top of the PLET 25A subsea. This may be achieved using for example, a Remotely Operated Vehicle (ROV), or arranged in advance by leading lines beneath the vessel. Once the abandonment and recovery cable 26 has been connected to the PLET 25A, the crane cable 28 may be disconnected and retrieved. The PLET 25A may then be winched toward the surface using the abandonment and recovery hoist. As the PLET 25A approaches a position where it is clear of the surface and vessel deck, (FIG. 19), the tower is then jacked inboard using the tower adjuster legs 16 in order to rest the PLET 25A on PLET handling equipment 24 bridging the slot in the tower supporting platform (FIG. 20). The PLET handling equipment 24 is then moved forward slightly to assist location of the PLET in line with the vessel firing line (FIG. 21). A tail piece is then welded to PLET 25A, and this assembly is then lowered past the rear of the vessel where it is then clamped by the hang off clamp 22, using the tower as previously described in relation to the mid sized PLET 25.

Note that the welding of the tail piece to each module 25, 25A can be performed at a position slightly aft of the tensioner firing line (C in FIG. 2), for example on the A & R line (B). This ensures the laying apparatus of the tower, tensioners, reels etc. are prepared, or remain prepared, with pipe for laying. This minimises the interruption of the normal laying process, which is occasioned by the need to install a PLET, ILT or other bulky article.

### Laying of in Line Tee (Normal Sized)

With reference again to FIGS. 3 to 5, when the pipelaying tower 10 is used to lay pipe, it is set at a suitable angle relative to the deck of the vessel V. This angle is chosen dependent upon the expected catenary angle of the pipe being laid, which can be either actively determined or calculated using known techniques. It may be necessary to translate the hang off clamp 22 aft or forward in slot 14 and/or tilt it to accommodate the range of angular positions of the tower 10 and the pipeline catenary angle.

With the tower 10 angled in line with the pipeline catenary angle, the normal sized In Line Tee (ILT) may be connected to the pipeline in a known manner as follows: —
1) Load the ILT in the PLET handling equipment 24 such that it is ready to be brought to the firing line;
2) Stop the pipelaying process and clamp the laid pipe using the hang off clamp 22;
3) Cut the portion of pipe between the hang off clamp 22 and the lower tensioner 20 on the tower and remove the cut section;
4) Bring the ILT to the firing line and weld it (simultaneously) to the pipeline being laid at the ILTs upper and lower ends to replace the cut section of pipe;
5) Transfer the laid pipeline catenary loads to tensioners 20 and then release the pipeline from hang off clamp 22; and
6) Disengage the PLET handling equipment 24 and move it forward away from the firing line.

The ILT may now be lowered along with the pipeline through the slot 14.

### Laying of in Line Tee (Mid Sized)

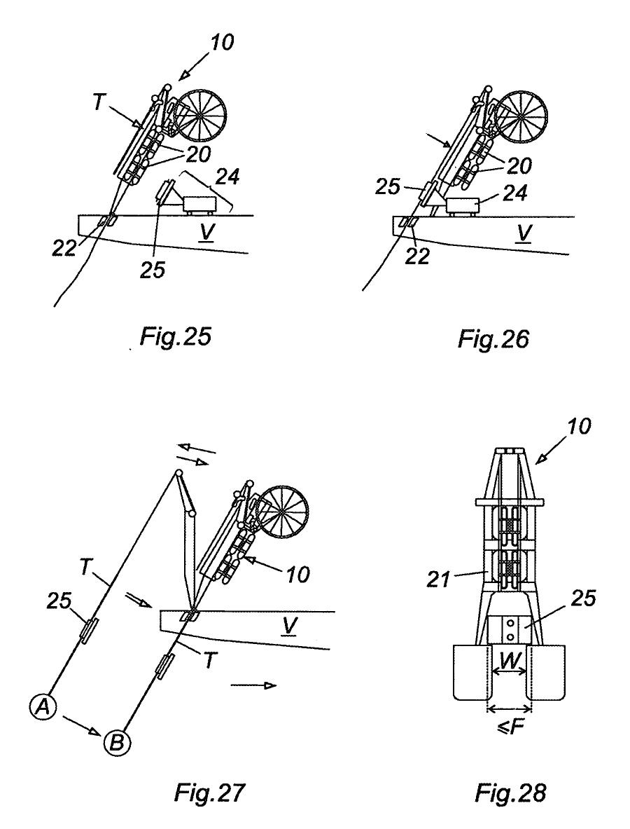

Referring to FIGS. 25 to 28, lowering of an ILT which has a width less than the minimum width F between the tower legs and greater than the width W of the slot 14 in the tower supporting platform will now be described.

With the tower 10 angled in line with the pipeline catenary angle, the mid sized ILT is loaded in PLET handling equipment 24 such that it is ready to be brought to the firing line. The pipelaying process is stopped and the hang off clamp 22 is then engaged around the laid pipeline. A portion of the pipeline is cut between the tensioners 20 and the hang off clamp 22 to accommodate the ILT. The ILT 25 is then brought to the firing line by the PLET handling equipment 24 (FIG. 26) where it is welded (simultaneously) at its lower end to the rest of the pipeline and at its upper end to a tail section T provided in the tower 10 (provision of this section is described further below). A & R cable 26 attaches the top of tail section T to the tower 10. The hang off clamp 22 is now released and the tension is carried by the tower 10 and hoist cable 26. The tower is now jacked to an overboard position to allow the mid-sized ILT to be lowered past the vessel transom without passing through the slot 14, as previously described in relation to the oversized first end PLET.

It should be noted that due to the catenary angle of the pipeline being laid, it may not be necessary to jack the tower 10 past the vertical in order to ensure that the oversized ILT clears the vessel's transom (this is best illustrated by FIG. 27).

### Laying of in Line Tee (Oversized)

Lowering of an over-sized ILT, which has a width greater than the minimum width F between the tower legs and greater than the width of the slot W in the tower supporting platform (i.e. oversized) requires that the ILT is moved rearward of the laying tower 10 in order that it can be positioned over the firing line for subsequent connection to the pipeline being laid. The ILT is too large to pass through the legs of the tower 10 and so it must be transferred using a deck mounted working crane 18 in the same way as described for the oversized first end PLET. Once positioned on the deck to the rear of the tower 10, the process for laying the oversized ILT is the same as that described previously in relation to lowering the midsized ILT and therefore will not be described further.

In each of the above described methods of laying an ILT, a tail section T of pipeline requires to be stored within the upper portion of the tower for subsequent connection to the top of the ILT (this provides an extension which allows the ILT to be lowered overboard more easily). One way of providing the tail section in the tower is to use a tail upending method. Starting with the tail section laid flat on the deck, the tail upending method involves connecting the PLET handling equipment 24 to a forward end of the tail, and the abandonment and recovery cable 26 of the tower to the rearward end of the tail. The PLET handling equipment 24 is then moved aft and the cable 26 winched upward simultaneously. This action causes the tail to be upended into the tower 10. Once the tail is located within the tower 10, tower pipe clamps are deployed to grab the tail.

### Laying Second End PLET (Normal Sized)

A second end PLET having a width which is both less than the minimum width F between the tower legs and less than the width W of the slot 14 in the tower supporting platform may be laid through the slot of the vessel in a known manner and will therefore not be described any further.

### Laying Second End PLET (Mid Sized)

Lowering of a mid-sized second end PLET, which has a width less than the minimum width F between the tower legs and greater than the width W of the slot 14 in the tower supporting platform (i.e. mid sized), involves a similar procedure to that employed while laying the first end PLET, as follows:

Once located at the vessel firing line (C), the second end PLET is welded to the last piece of pipeline being laid. A & R hoist block 37 is then connected to the top of the last piece of pipeline. The weight of the PLET is then taken from the deck of the vessel V by winching the second end PLET clear of the deck. At this point the cursor sheaves 36 are opened to disengage the cursor 32 from the cable 26 and block 37. The PLET 25 is then moved to an overboard position, which is rearward of the vessel transom, by jacking the tower 10 to an overboard position using tower adjuster legs 16. To achieve this overboard position, the tower 10 may not need to be jacked as far as an upright position due to the catenary angle of the laid pipeline (see FIG. 27). The PLET 25 is then lowered past the tower supporting platform (clear of the slot 14) using the winching means on the tower 10 (FIG. 27). The PLET can then be lowered all the way to the sea bed using the abandonment and recovery cable 26. In this regard, it may be preferable to return the tower 10 to an inboard position either before or during the final abandonment of the PLET to the sea bed.

### Laying Second End PLET (Oversized)

Lowering of an over-sized PLET, which has a width greater than the minimum width F between the tower legs and greater than the width W of the slot 14 in the tower supporting platform requires that the PLET is moved rearward of the laying tower 10 in order that it can be positioned over the firing line for connection to the laid pipeline. The PLET is too large to pass through the legs of the tower 10 and so it must be transferred using a deck mounted working crane 18 in the same way as described for the oversized first end PLET. Once positioned on the deck to the rear of the tower 10, the process for laying the oversized PLET is the same as that described above in relation to lowering the midsized second end PLET and therefore will not be described further.

Modifications and improvements may be made to the foregoing without departing from the spirit and scope of the invention.

Another form of tower bypass means could be provided instead of the deck mounted crane 18. For example, the PLETs or ILTs may be provided with mud mats which can be temporarily folded over to reduce their overall width. This allows PLETs or ILTs (which would otherwise be too large) to fit through the slot and/or tower legs by moving the PLET or ILT using longitudinal movement means such as the PLET handling equipment 24. If a suitable crane is not available on board, a separate crane vessel could be in attendance. The module may even be pre-stored on the seabed to be lifted by the A & R hoist.

Whereas the normal pipelaying modes of the tower will keep it inside a balance point, such that the adjusting arms 16 are kept in compression, extending the arms to incline the tower beyond vertical for use as an overboarding crane may take the tower beyond its balance point. In that case, the legs must be designed to function in tension as well as in compression. As an alternative, or as a safeguard, the tower in crane mode may be restrained by tendons such as cables, running generally in parallel with the adjusting legs, similar to the cables that support a conventional shear leg crane.

1. Pipe laying apparatus for overboarding an article from a pipe laying vessel, the apparatus comprising:
a pipe laying tower mountable substantially above a tower supporting platform of the vessel, the tower including tensioning apparatus for suspending a pipeline being laid from the pipelaying vessel into the sea;
means for adjusting inclination of the tower to align said tensioning apparatus with a departure axis of a pipeline being laid; and
apparatus for handling large articles, whereby articles too large to pass the tower supporting platform of the vessel may be supported and maneuvered first outboard of said tower supporting platform, then lowered and brought beneath said tower supporting platform back into line with the departure axis for connection to the pipeline, said apparatus for handling large articles including:
a hoist for suspending said large articles from an upper part of said tower; and
means for adjusting the inclination of the tower to an angle beyond that of the departure axis, such that said hoist suspends the article outboard of the tower supporting platform for lowering past the tower supporting platform.

2. Pipe laying apparatus according to claim 1, wherein the tower supporting platform is provided with a slot through which pipe may be laid during a typical pipe laying operation, where the width of the slot determines whether the large article is able to pass through the slot into the sea without having to be overboarded by the apparatus.

3. Pipe laying apparatus according to claim 1, wherein the means for adjusting the inclination of the tower is capable of moving the tower to an angle at least equal to ninety degrees relative to the deck of the vessel, such that the top of the tower projects outboard from the tower supporting platform.

4. Pipe laying apparatus according to claim 3, wherein the adjusting means is also capable of at least partially securing the tower in said position.

5. Pipe laying apparatus according to claim 1, wherein the means for adjusting inclination of the tower to align said tensioning apparatus with a departure axis and the means for adjusting the inclination of the tower to an angle beyond that of the departure axis comprise the same means.

6. Pipe laying apparatus according to claim 1, wherein the means for adjusting inclination of the tower comprises at least an adjuster leg extending between a portion of the tower and a portion of the vessel deck.

7. Pipe laying apparatus according to claim 1, wherein the hoist comprises at least a sheave carried at an upper part of the tower and a hoist cable wrapped therearound.

8. Pipe laying apparatus according to claim 7, wherein the hoist further comprises a cursor mechanism for selectively guiding the cable along the tower, where the cursor mechanism is selectively disengageable and reengageable with the cable when the hoist raises the article past the rear of the vessel.

9. Pipe laying apparatus according to claim 8, wherein the cable comprises an abandonment and recovery line.

10. Pipe laying apparatus according to claim 8, wherein the cursor mechanism comprises, winch means, winch cable and sheave, an abandonment trolley capable of restraining the winch cable along the height of the tower, and an underwater hook.

11. Pipe laying apparatus according to claim 10, wherein the abandonment trolley is provided with a sheave which, when the abandonment axis is angled away from the tower angle, assists movement of the winch cable and allows the winch cable to be diverted, above the sheave, in line with the tower axis.

12. Pipe laying apparatus according to claim 1, wherein the tower comprises an A-frame having legs laterally spaced apart to provide a tower aperture for passage of modules from storage to the departure axis and where each leg is hinged to the tower supporting platform at pivot points.

13. Pipe laying apparatus according to any claim 12, wherein a tower aperture is provided by the A-frame where the width of the aperture is substantially defined by the distance between the spaced apart legs and the height of the aperture is substantially defined by the distance between the deck of the vessel and a cross brace member of the A-frame.

14. Pipe laying apparatus according to claim 1, further comprising pipe laying tower bypass means for moving an article, having dimensions greater than the tower aperture, from a location which is forward of the pipe laying tower to a location rearward of the pipe laying tower.

15. Pipe laying apparatus according to claim 14, wherein the tower bypass means comprises a crane capable of lowering the article overboard to a subsea position thereby allowing the cable of the hoist to be connected to the article and the article winched onboard to the rearward position.

16. A method of overboarding an article from a pipe laying vessel in a pipe laying operation, the method comprising:
providing a pipe laying tower substantially above a tower supporting platform of the vessel;
paying out a pipeline using tensioning apparatus in the tower past the tower supporting platform and into the sea, the tower being inclined to align said tensioning apparatus with a departure axis of the pipeline being laid;
prior to or after paying out said pipeline, using a hoist to suspend an article from an upper part of said tower;
adjusting the inclination of the tower to an angle beyond that of the departure axis, such that said hoist suspends the article outboard of said tower supporting platform;
using the hoist to lower the article past the tower supporting platform.

17. A method according to claim 16, further comprising, with the article suspended outboard of and below the level of the tower supporting platform, adjusting the inclination of the tower back to said departure angle so as to bring the article onto the departure axis below the tower supporting platform; and
connecting said article to a section of pipeline held in the tensioning apparatus prior to paying out pipeline.

18. A method according to claim 17, further comprising providing a slot in the tower supporting platform and paying out the pipeline through said slot and into the sea, and wherein the step of adjusting the inclination of the tower to an angle beyond that of the departure axis suspends the article outboard of said slot; and
using the hoist to lower the article past the slot rather than through it.

19. A method according to claim 16, further comprising, after paying out a length of pipeline, gripping the pipeline below the tensioning apparatus and cutting it to form an upper end of said pipeline held in the slot;
prior to passing said article outboard of the vessel, using said hoist, attaching a lower end of the article to the upper end of the pipeline.

20. A method according to claims 16 to 19, wherein the step of adjusting the inclination of the tower includes moving the tower to an angle at least equal to ninety degrees relative to the deck of the vessel such that the top of the tower projects overboard from the slot.

21. A method according to claim 16, wherein the step of adjusting the inclination of the tower to align said tensioning apparatus with a departure axis and the step of adjusting the inclination of the tower to an angle beyond that of the departure axis comprises a combined step using a single adjusting means.

22. A method according to claim 16, wherein the step of using a hoist to suspend said large articles from an upper part of said tower comprises hoisting the article with a hoist provided at the tower wherein the hoist comprises at least a sheave, a winch located at the tower and a hoist cable wrapped therearound.

23. A method according to claim 16, wherein the step of hoisting the article further comprises disengaging a cursor mechanism from the hoist cable as the article is being hoisted past the rear of the vessel.

24. A method according to claim 16, wherein the step of hoisting also includes re-engaging the cursor mechanism when the article is suspended below the slot.

25. A method according to claim 16, wherein the method also comprises the step of moving a large article having dimensions greater than an aperture in the tower, from a location which is forward of the tower to a location rearward of the tower by bypassing the tower and wherein the step of bypassing the tower comprises lowering the article from the forward location into the sea using a crane, transferring the article to the hoist means of the tower, and raising the article onto the deck of the vessel at the rearward position.
